(19) United States
(12) Patent Application Publication
(10) Pub. No.: US 2020/0165777 A1
(43) Pub. Date: May 28, 2020

(54) PRESS COVER AND USE THEREOF

(71) Applicant: VOITH PATENT GMBH, HEIDENHEIM (DE)

(72) Inventors: DELPHINE DELMAS, HEIDENHEIM (DE); UWE MATUSCHCZYK, GEISLINGEN (DE); HERMANN REICHERT, HEIDENHEIM / OGGENHAUSEN (DE); MICHAEL WOKUREK, WIEN (AT)

(21) Appl. No.: 16/630,504

(22) PCT Filed: Jun. 13, 2018
(86) PCT No.: PCT/EP2018/065576

§ 371 Date: Jan. 13, 2020

(30) Foreign Application Priority Data
Jul. 12, 2017 (DE) 10 2017 115 592.9

(51) Int. Cl. D21F 3/02; D21F 3/04; D21F 3/08; B29K 75/00; C08G 18/10

(52) U.S. Cl. CPC D21F 3/0236; D21F 3/045; C08G 18/10; D21F 3/0245; B29K 2075/00; D21F 3/086

(57) ABSTRACT

A press cover or jacket includes at least one first polymer layer. The polymer layer contains or has been produced from a polyurethane, and the polyurethane has been formed from a prepolymer and a crosslinker. The prepolymer is a reaction product of naphthalene 1,5-diisocyanate or phenylene 1,4-diisocyanate and at least one polyol selected from a polycarbonate polyol, a polytetramethylene ether glycol, polyether polycarbonate polyol or mixtures thereof. A press using the press cover is also provided.

The invention proceeds from a press cover, especially for a press apparatus for treatment of a fibrous material layer, for example for smoothing or dewatering thereof, with specifics according to the independent claims.

Press apparatuses such as shoe presses have long been part of modern papermaking machines. They essentially comprise a shoe in a stationary arrangement (also called press shoe) that extends in a machine cross direction, and a circumferential press cover around the stationary shoe. The press cover is deformable and takes on essentially a tubular shape in operation. The shoe is formed such that it forms a press nip (press gap) with an opposing roll. The press nip is defined by the contact area of the opposing roll in the shoe. The shoe is designed to be movable and can be moved against the opposing roll.

Enormous demands are placed on the press cover in relation to its stability, namely with regard to surface hardness, and resistance to pressure, temperature and hydrolysis. The press cover is additionally exposed to significant flexural cycling stresses during operation. On arrival at the edge of the shoe—upstream of the press nip viewed in rotation direction of the press cover—there is initially flexion with a comparatively small radius. This immediately becomes an opposing flexion on passage through the press nip. On exit at the other edge of the shoe, i.e. downstream of the press nip viewed in rotation direction of the press cover, there is again an opposing flexion. This deformation of the press cover on entry and exit is also referred to as cyclical nip. It is readily apparent that the tendency of the press cover to break particularly at this point is very high by virtue of the high mechanical stress. Correspondingly, there are many known measures from the prior art that are intended to increase the stability of the press cover.

The press cover must thus have sufficient flexibility in order that it can be guided around the shoe, it must have sufficient stiffness that it does not become deformed or compressed too significantly in the nip under the press load, and it must have sufficient wear resistance. Press covers therefore consist of a single- or multilayer polymer layer, preferably of polyurethane, into which may be embedded reinforcing filaments in the form of nonwoven scrims or woven fabrics.

The present invention relates to such articles of the generic type that have been specified at the outset.

Generic press covers have become known from US 2015/0308044 A1 and DE 69701221 T2 inter alia.

Even though press covers known from the prior art have sufficient flexibility and simultaneously sufficient stiffness, there is a need for improvement in the chemical stability thereof, especially toward water and oil, the abrasion resistance thereof, the resistance thereof to cracking and crack propagation and the swelling characteristics thereof.

It is accordingly an object of the invention a press cover that avoids the disadvantages of the prior art.

The object is achieved by the features of the independent claims. Particularly preferred and advantageous embodiments of the invention are detailed in the dependent claims.

The present invention is based on a single general concept, namely that of effectively countering the disadvantages mentioned at the outset by the use of naphthalene 1,5-diisocyanate (NDI) or phenylene 1,4-diisocyanate (PPDI) as isocyanate and a polyol containing polycarbonate or polytetramethylene ether glycol (PTMEG) in the at least one polymer layer of the press cover. In other words, each of the three alternatives protected by claims 1, 2 and 6 has at least one polymer layer that satisfies these features. These three alternatives of the single inventive concept also result in a common technical relationship: the PPDI- or NDI-based polymer layers together with the polyol of the invention cited at the outset lead to surprisingly high flexibility, high stiffness and chemical stability, especially toward water and oil. At the same time, there is an increase in the abrasion resistance, cracking resistance, crack propagation resistance and swelling characteristics thereof. This is found particularly when the press cover is grooved, i.e. has grooves arranged in a distribution over the circumference on the radially outermost shell surface thereof (or on the corresponding shell surface of the radially outermost polymer layer). The elements of the polymer layer that bound the grooves, into which the grooves have been incorporated, then withstand the cyclical nip particularly well. They are deformed less significantly than the known press covers. As a result, the dewatering volume of the press cover bounded by the grooves together with the opposing roll in the nip remains constant. This ensures equal dewatering performance in the nip.

It has been found that NDI, by comparison with PPDI, achieves the advantages of the invention particularly efficiently for particular applications.

If the invention says that something has been produced from a material, what this means is that it has been produced partly or entirely from such a material.

If the invention refers to an isocyanate, what is meant is a polyisocyanate such as diisocyanate.

In the context of the invention, what is meant by a press apparatus is, for example, a shoe press, for example for dewatering or treatment, such as smoothing, of a fibrous material web. The shoe press comprises a shoe press roll and an opposing roll that together form or bound a press nip. The shoe press roll further comprises a circumferential press cover and a fixed press element, called the press shoe. The latter rests on a supporting, likewise stationary yoke—for example via hydraulic press elements—and is pressed onto the circumferential press cover. The press cover revolves relative to the fixed press shoe and yoke and is thus pressed onto the opposing roll in the press nip. Press shoe and yoke are arranged radially within the press cover. The term “fixed” is understood to mean that the press element does not revolve relative to the shoe press roll or the opposing roll, but can move in a translational manner—toward and away from the opposing roll, preferably in radial direction thereof—and hence relative to the opposing roll. In addition to the fibrous material web and the press cover, it is possible for one or more press felts that circulate continuously in circumferential direction and/or further continuously circulating press belts to be guided through the press nip of the shoe press. Such a shoe press may of course comprise more than one press nip.

A fibrous material web in the context of the invention is understood to mean a laid scrim or unstructured tangle of fibers, such as wood fibers, plastic fibers, glass fibers, carbon fibers, additions, additives or the like. For example, the fibrous material web may take the form of a paper, cardboard or tissue web. It may essentially comprise wood fibers, where small amounts of other fibers or else additions and additives may be present. This is a matter for the person skilled in the art according to the individual use.

A press cover in the context of the invention is understood to mean a belt, hose or cover which, as described, is guided together with a fibrous material web through the press nip of a shoe press. The fibrous material web can be dewatered in operation as intended by contacting the radially outermost surface (polymer layer) of the press cover with a press felt that directly bears the fibrous material web to be dewatered. According to the embodiment of the press device, for example for smoothing thereof, the press cover in operation as intended may also come into direct contact with the fibrous material web. The press cover is in the form here of a continuous cover (hose) which is endless in circumferential direction about its longitudinal axis. At its axial ends—viewed in breadth direction (along the longitudinal axis)—it is open. It is thus possible for the press cover to be held by two lateral tension plates at its axial ends, in order to form the shoe press roll. Rather than being guided by the two lateral tension plates, the press cover, as is the case for open shoe presses, may be guided over the press shoe and multiple guide rolls. Irrespective of whether the press cover is guided by the tension plates or the guide rolls, the press shoe (or the guide rolls) come(s) (intermittently) into contact with part of the radially innermost surface of the press cover. The radially outermost surface of such a press cover, i.e., for example, the radially outermost polymer layer thereof, may have been provided with grooves and/or blind holes.

The press cover may have been partly or completely manufactured from a polymer. The polymer used may be a castable, curable, preferably elastomeric, polymer such as polyurethane. The polymer may consequently be formulated as a cast elastomer.

What is meant by “polymer layer” is a layer that comprises or has been produced entirely from such a castable, curable, preferably elastomeric, polymer. The polymer layer may preferably be a cured layer that has been produced in one piece by primary shaping. In other words, it has been made by primary shaping in monolithic form, i.e., for example, by casting. The term “one-piece” also includes cases in which one layer has in turn been produced from multiple strata of the same material in the casting of the polymer. However, this is only true if these strata are essentially no longer visible after the curing, and the result is instead a single, preferably uniform layer. The same is correspondingly true of the finished press cover.

In the case of provision of multiple polymer layers, these may be arranged one on top of another viewed in radial direction—at least in sections over the width of the press cover. “At least in sections over the width of the press cover” means that the press cover has only a single layer, for example at its axial ends, whereas it is in two-layer or multilayer form between the axial ends. In other words, it is possible for the thickness of the press cover—and hence the thickness of the individual polymer layers—to vary in sections along the longitudinal axis in a section through the longitudinal axis thereof. For example, the radially outermost polymer layer in the region of the widthwise edges of the press cover may be lower than in the middle of the press cover. In other words, in the region of the widthwise edges, the radially outermost polymer layer may be less thick than a radially inner or radially innermost polymer layer. Preferably, exactly one, two or three polymer layer(s) is/are provided. These may be in identical form in terms of their polymer or may vary in terms of their hardness or stoichiometry of the prepolymer. A total thickness of the finished press cover in a section through the longitudinal axis thereof, measured in radial direction, may be 5 to 10 mm, preferably 5 to 7, more preferably 5 to 6 mm. According to the invention, in the case of provision of a single layer, the press cover may have been manufactured from just one casting, i.e. in monolithic form, such that the single layer has the thickness just mentioned.

A finished press cover in the context of the invention is one wherein the at least one polymer layer has been cured and possibly finally processed, i.e. is ready for use for the purpose stated at the outset, in a shoe press for example. Analogously, “finished polymer layer” means a layer that has been cured.

In principle, it is conceivable that the press cover has a reinforcing structure. The term “reinforcing structure” in the context of the invention means a reinforcement of the at least one layer containing or consisting of the polymer—i.e. the polymer layer. The reinforcing structure may be entirely embedded here into the polymer layer, such that the reinforcing structure does not extend beyond the boundary of the polymer layer. In other words, the polymer layer assumes the role of a matrix that surrounds the reinforcing structure and binds to the matrix as a result of adhesion or cohesion forces. Such a reinforcing structure may include textile linear structures—e.g. yarns or twines—and/or textile fabrics—for example woven fabrics, loop-formed knitted fabrics, loop-drawn knitted fabrics, braids or scrims—and may be producible from a corresponding starting material, for example by winding. “Starting material” is understood to mean that material or semifinished product by means of which the reinforcing structure of the finished press cover of the invention is produced.

What is meant by the term “modulus of elasticity” is a material index from materials technology that describes the correlation between stress and strain on deformation of a solid body, here the polymer of the press cover with linear-elastic characteristics. In the determination of the modulus of elasticity of a polymer of the invention, it is usually more advantageous to ascertain the modulus of elasticity under pressure than the modulus of elasticity under tension. For this purpose, the sample may corresponding to the same hold time as ascertained in the Shore A hardness measurement (here, for example, 15 s) at 2% elongation. This has the advantage that the measurement conditions correspond to the customary conditions for determination of modulus of elasticity in the short tensile test. The deformation characteristics of the sample here are virtually linear; compressive strength in that case corresponds essentially to tensile strength.

According to the invention, the crosslinker may include butane-1,4-diol or hydroquinone 1,4-bis(2-hydroxyethyl) ether, MCDEA (or mixtures of these) or at least one aliphatic or aromatic diamine or alkanolamine.

If “aliphatic” is mentioned, this also includes the term “cycloaliphatic”.

The percentages of the components of the crosslinker may be chosen such that they do not exceed 100 mol % in total.

In principle, it would be conceivable for the crosslinker to include a further component selected from at least one polyol, preferably bifunctional polyol, having a molecular weight of preferably 1000 to 4000 g/mol, and preferably between 1200 and 3500 g/mol, such as polyester polyol, especially polycaprolactone polyol; polyether polyols, especially polytetramethylene ether glycol (PTMEG), polypropylene glycol (PPG), polyethylene glycol (PEG), polyhexamethylene ether glycol, polycarbonate polyol, polyether carbonate polyol, polybutadiene polyol, perfluoropolyether polyol, silicone polyol or mixtures thereof.

The particle number fraction (i.e. the molar percentage) of the respective component of the crosslinker may be based on the total particle number of all components (of the overall mixture) of the crosslinker or else solely on the proportion of the particles of components of the crosslinker which functional groups, such as molecules bearing active hydrogen atoms (e.g. hydroxyl and primary or secondary amines).

The components of the invention may be added to the crosslinker, for example, by the process of the invention before they are reacted with the prepolymer.

When reference is made to aliphatic amines in the context of the invention, this may mean primary aliphatic amines, secondary aliphatic amines or tertiary aliphatic amines. In a preferred embodiment, however, the aliphatic amines are primary aliphatic amines since the advantages of the invention are best achieved therewith. This is analogously applicable to the aromatic or aliphatic amines mentioned, such as diamines.

In the context of the invention, alkanolamines, also called amino alcohols, is understood to mean a substance class of organic compounds that simultaneously contains at least two functional groups, including a hydroxyl group and an amino group. The latter here may be a primary, secondary or tertiary amine function. A bifunctional compound is, for example, a compound containing two such functional groups. The alkanolamine is preferably selected from monoethanolamine, N-propylalcoholamine or mixtures thereof. The industrially most important representatives of the amino alcohols are mono-, di- and triethanolamine, dimethylaminoethanol, diethylaminoethanol, N-methyldiethanolamine, and mono-, di- and triisopropanolamine. These too could also be used alone or in the form of a mixture according to the present invention.

The NDI-based prepolymer preferably has an NCO content of 4% to 20% by weight, preferably 5% to 14% by weight. As a result, it is possible to provide more reactive groups in the polymer, which allows better adjustability of the hardness of the press cover.

The advantages of the invention described at the outset are satisfied particularly satisfactorily when the modulus of elasticity and/or the hardness of the first polymer layer is/are greater than the corresponding value of the second or third polymer layer.

The invention also relates to a press roll, such as shoe press roll, for a shoe press for dewatering of a fibrous material web, wherein the press roll includes at least one press cover of the invention.

The invention also relates to a shoe press for dewatering of a fibrous material web, preferably a paper, cardboard, tissue or pulp web, comprising a press roll and an opposing roll that together form or bound a nip, wherein the press roll comprises a circumferential press cover, wherein the press cover takes the form according to the invention.

The invention finally relates to the use of a press cover of the invention for a press, such as shoe press for dewatering of a fibrous material web, preferably a paper, cardboard, tissue or pulp web.

The invention is elucidated in detail hereinafter with reference to the drawings without restriction of generality. The drawings show:

FIG. 1 a schematic side view as a partial section of a shoe press with a press cover in a working example of the present invention.

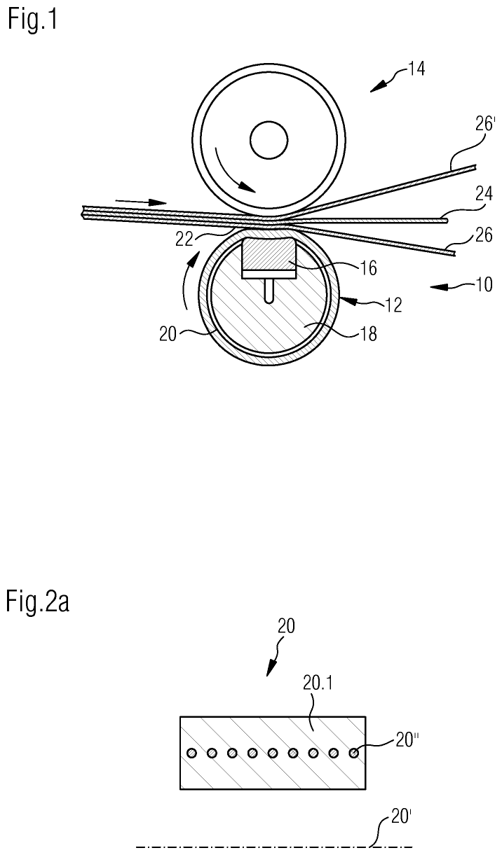

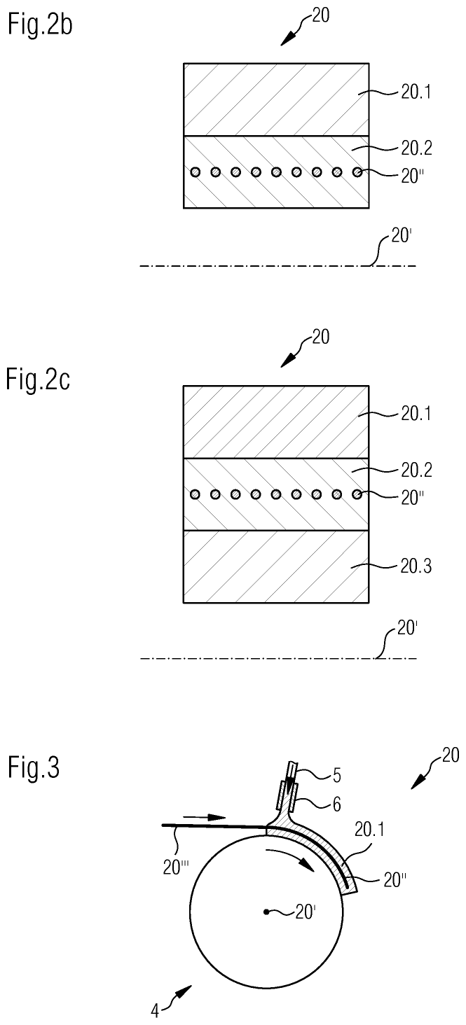

FIGS. 2a, 2b and 2c working examples of a press cover formed in accordance with the invention, each viewed in a section through the longitudinal axis thereof;

FIG. 3 a highly schematic diagram of the performance of the process of the invention in a side view of an apparatus for production of the press cover.

FIG. 1 shows a shoe press 10 which, in the present context, comprises a press roll of the invention, such as a shoe press roll 12, and an opposing roll 14. Shoe press roll 12 and opposing roll 14 are arranged parallel to one another with regard to their longitudinal axes. Together, they form or bound such a nip 22.

While the opposing roll 14 here consists of a roll of cylindrical configuration that rotates about its longitudinal axis, the shoe press roll 12 is composed of a shoe 16, a stationary yoke 18 that bears it, and a press cover 20. Shoe 16 and yoke 18 are in a fixed arrangement in relation to the opposing roll 14 or the press cover 20. This means that they do not rotate. The shoe 16 is supported here by the yoke 18 and pressed onto the radially innermost surface of the press cover 20 that revolves relative thereto via hydraulic press elements (not shown). The press cover 20 that surrounds shoe 16 and yoke 18 in circumferential direction rotates here about its longitudinal axis in the opposite sense from the opposing roll 14. Owing to the concave configuration of the shoe 16 on its side facing the opposing roll 14, the result is a comparatively long nip 22.

The shoe press 10 is especially suitable for dewatering of fibrous material webs 24. In the operation of the shoe press, a fibrous material web 24 is guided through the press gap 22 with one or two press felts 26, 26′. In the present case, there are exactly two press felts 26, 26′ that accept the fibrous material web 24 between them in a sandwich-like manner. In the course of passage through the nip 22, the press felts 26, 26′ exert a pressure indirectly on the fibrous material web 24 in the nip 22. This is accomplished in that the radially outermost surface of the opposing roll 14 on the one hand and the radially outermost surface of the press cover 20 come into direct contact with the corresponding press felts 26, 26′. The liquid exiting from the fibrous material web 24 is temporarily absorbed by the press felt(s) 26, 26′ and any recesses provided in the press cover surface (not shown). After leaving the nip 22, the liquid absorbed by the depressions of the press cover 20 is spun off before the press cover 20 enters the press gap 22 again. In addition, the water absorbed by the press felt 26, 26′ can be removed by suction elements after departure from the press gap 22.

The press cover shown in FIG. 1 may, as shown in the figures that follow, be executed in accordance with the invention.

FIGS. 2a, 2b and 2c show different alternatives of the common concept of the invention in a partial cross section, not to scale, through the longitudinal axis 20′ of the finished press cover 20. The distance of the longitudinal axis 20′ from the radially innermost surface of the corresponding polymer layer is likewise not shown to scale.

FIG. 2a shows a press cover 20 in the first alternative of the invention with a single polymer layer 20.1. In the present context, a reinforcing structure 20″ has been embedded into the single polymer layer 20.1. This is indicated by the hatched circles that may be textile areal or linear structures such as fibers. The reinforcing structure is fully embedded into the polymer layer 20.1, meaning that the reinforcing structure 20″ does not extend beyond the bounds of the polymer layer 20.1.

The first polymer layer 20.1 has been formed here from polyurethane which is produced from a prepolymer and a crosslinker. The prepolymer is a reaction product of naphthalene 1,5-diisocyanate (NDI) or phenylene 1,4-diisocyanate (PPDI) as isocyanate and at least one polyol selected from a polycarbonate polyol, a polytetramethylene ether glycol (PTMEG), polyether polycarbonate polyol or mixtures of these.

FIGS. 2b and 2c each show, as a modification of FIG. 2a, a multilayer press cover 20. For instance, according to FIG. 2b, which corresponds to an embodiment of the second alternative of the invention, exactly two polymer layers are provided, namely a first 20.1 and a second 20.2. In the present case, the first polymer layer 20.1 is simultaneously the radially outermost polymer layer of the press cover 20. On the other hand, the second polymer layer 20.2 is simultaneously the radially innermost polymer layer of the press cover 20. As shown, a reinforcing structure 20″ may have been provided in the second polymer layer 20.2. In the present case, the first and a second polymer layer 20.1, 20.2 have been produced from a polyurethane. The latter is obtainable from a prepolymer and a crosslinker. According to the second alternative, the prepolymer of the first polymer layer 20.1 is a reaction product of naphthalene 1,5-diisocyanate (NDI) and at least one polyol. The latter is selected from a polycarbonate polyol, a polyether polycarbonate polyol or mixtures of the two.

On the other hand, the prepolymer of the second polymer layer 20.2 is a reaction product of naphthalene 1,5-diisocyanate (NDI) and at least one polytetramethylene ether glycol (PTMEG). Alternatively, this may have been produced from a phenylene 1,4-diisocyanate (PPDI), diphenylmethane 4,4′-diisocyanate (MDI), toluene 2,4-diisocyanate (TDI) or 3,3′-dimethyl-4,4′-biphenylene diisocyanate (TODI) and a polyol. The latter may, for example, be polytetramethylene ether glycol (PTMEG).

For the rest, the statements already made for FIG. 2a are applicable.

FIG. 2c shows a three-layer press cover with a first polymer layer 20.1—the radially outermost here, a radially innermost, third polymer layer 20.3, and a second polymer layer 20.2 arranged between the two in a sandwich-like manner. The arrangement—as also in the diagram of FIG. 2b—is viewed proceeding from the longitudinal axis 20′ of the press cover 20 in the radial direction thereof. In the present case, only in the second polymer layer 20.2 is a (single) reinforcing structure 20″ provided. This could of course also be different, and so such a reinforcing structure 20″ could alternatively or additionally also be disposed in the first polymer layer 20.1 and/or the third polymer layer 20.3. Here too, the first and second polymer layer 20.1, 20.2 have each been produced from or contain such a polyurethane. The corresponding prepolymer of the first polymer layer 20.1 here may be a reaction product of phenylene 1,4-diisocyanate (PPDI), NDI, TODI, TDI or diphenylmethane 4,4′-diisocyanate (MDI) or a mixture of the two. The corresponding at least one polyol may be selected from a polycarbonate polyol, a polyether polycarbonate polyol or mixtures thereof. The prepolymer of the second and third polymer layers 20.2, 20.3 here is a reaction product of naphthalene 1,5-diisocyanate (NDI) and at least one polytetramethylene ether glycol (PTMEG).

In respect of the embodiment of FIG. 2d, moreover, the statements already made for FIGS. 2a and 2b are applicable.

The use of the polyurethane in at least one of the polymer layers 20.1, 20.2, 20.3 of the three alternatives of the invention guarantees the particularly high stability of the press cover 20 with regard to the mechanical and dynamic properties such as stability, surface hardness, resistance to pressure, temperature and hydrolysis, and low swelling. These properties lead to a prolonged lifetime of the press cover 20 in operation.

FIG. 3 shows, in a highly schematic side view, an apparatus for production of a press cover 20 of the invention. The apparatus in the present context has exactly one cylindrical winding mandrel 4, with application here, for example, of a starting material 20′″ in spiral form to the radially outermost cover surface thereof. After embedding into the polymer, the starting material 20″″ forms the reinforcing structure 20″ of the finished press cover 20 of the invention.

The diagram shows an initial stage of the production process. In the present case, for this purpose, one end of the starting material 20′″ has been secured to a polymer disposed at the outer extent of the winding mandrel 4. Apart from the schematic diagram shown, it would also be possible for one end of the starting material 20″ to lie on or have been applied to the winding mandrel 4, i.e. directly, without initial provision of a polymer between starting material 20″ and winding mandrel 4. The starting material 20′″ here may be a textile fabric or linear structure.

The winding mandrel 4 is mounted so as to be rotatable about its longitudinal axis 20′, which corresponds to the longitudinal axis of the press cover to be produced. Longitudinal axis 20′ runs at right angles here into the plane of the drawing. A casting material, such as castable, curable elastomeric polymer, e.g. polyurethane, is applied via a conduit 5 through a casting nozzle 6 downward onto the radially outermost cover surface of the winding mandrel 4 or onto the starting material 20′″. Such a casting material may be chosen, for example, with respect to its pot life and viscosity such that it does not drip off the winding mandrel 4 in the course of casting. During this period, the winding mandrel 4 is rotated about its longitudinal axis in the direction of the arrow. Simultaneously with this rotation, the casting nozzle 6 is guided parallel to and along the longitudinal axis 20′ relative to the winding mandrel 4 by means of a suitable guide (not shown in detail in FIG. 3). Simultaneously with the casting application of the casting material, the starting material 20′″ is unrolled and wound on the rotating winding mandrel 4, for example to give windings. It is possible here for the casting material to get through the starting material 20′″ through to the winding mandrel 4. The polymer in this example, after the curing step, forms a first, preferably elastomeric polymer layer 20.1 of the press cover, which is the radially innermost here, of which FIG. 3 shows just part.

The casting material exiting from the casting nozzle 6 is a mixture of a prepolymer and a crosslinker. The former is provided from a prepolymer vessel (not shown) in which it is stored or stirred up. The prepolymer may comprise an isocyanate of the invention and a polyol. It may be present in the prepolymer vessel, for example, in the form of a prepolymer of the substances just mentioned.

The crosslinker may be provided in a crosslinker vessel. The crosslinker may comprise BDO, HQEE, MCDEA, at least one diamine, such as an aromatic or aliphatic diamine or alkanolamine, EDA, 2,2,4-trimethylhexane-1,6-diamine, 2,4,4-trimethylhexane-1,6-diamin, HMDA, DETDA, 4,4′-diaminodicyclohexylmethane or DMTDA. In principle, mixtures of the aforementioned substances would also be conceivable. The crosslinker may alternatively comprise a further component, such as at least one polyol and/or else a catalyst. The crosslinker with its corresponding components may be stirred up directly in the crosslinker vessel. It is, however, also conceivable that the apparatus comprises a corresponding individual vessel for each of the components that is connected to the crosslinker vessel in a flow-conducting manner via conduits (not shown), in order to produce the crosslinker of the invention in the crosslinker vessel.

Prepolymer vessel and crosslinker vessel are assigned to the apparatus for production of a press cover 20. They are connected via conduits (likewise not shown) in a flow-conducting manner to a mixing chamber (not shown) connected upstream of the casting nozzle 6 in flow direction. The prepolymer/crosslinker mixture is thus produced upstream of and outside the casting nozzle 6, i.e. mixed in the mixing chamber. Irrespective of the production of the mixture, this is then applied to the surface of the winding mandrel 4 to form the at least one polymer layer 20.1 of the press cover 20.

By means of such a continuous casting operation, which is also known as rotary casting, a continuous press cover 20 that forms an intrinsically closed cylinder about its longitudinal axis 20′ is thus gradually produced over the width of the winding mandrel 4, the internal circumference of which corresponds essentially to the outer circumference of the winding mandrel 4.

In principle, it would be conceivable to wind the starting material 20′″ onto more than one winding mandrel 4 shown in FIG. 3. For example, it would be possible to provide two winding mandrels that could be arranged in parallel at a distance from one another with regard to their longitudinal axes. Alternatively, it would also be conceivable to apply the polymer to the radially inner cover surface of the winding mandrel 4 as well, for example in the manner of spinning.

Irrespective of the embodiment addressed, the finished press cover 20 is finally removed from the at least one winding mandrel 4.

As shown in the figures, the press cover 20 takes the form according to the invention. This means that the at least one polymer layer has been produced (partly or completely) from a polyurethane. The polyurethane here has been formed from a prepolymer of the invention—which is a reaction product of at least one polyol with an isocyanate—and a crosslinker. The crosslinker comprises, for example, the components mentioned at the outset. The former may also include further components known to the person skilled in the art.

1-15. (canceled)

16. A press cover, comprising:
at least one first and one second polymer layer each containing or being formed of a polyurethane, said polyurethane being formed from a prepolymer and a crosslinker;
said prepolymer of said first polymer layer being a reaction product of naphthalene 1,5-diisocyanate as an isocyanate and at least one polyol selected from a polycarbonate polyol, a polyether polycarbonate polyol or mixtures of a polycarbonate polyol and a polyether polycarbonate polyol.

17. The press cover according to claim 16, wherein said prepolymer of said second polymer layer is a reaction product of:
naphthalene 1,5-diisocyanate as an isocyanate and polytetramethylene ether glycol as a polyol, or
phenylene 1,4-diisocyanate, diphenylmethane 4,4′-diisocyanate, toluene 2,4-diisocyanate or 3,3′-dimethyl-4,4′-biphenylene diisocyanate as an isocyanate and a polyol or polytetramethylene ether glycol.

18. The press cover according to claim 17, wherein said first polymer layer is a radially outermost polymer layer relative to a longitudinal axis of the press cover.

19. The press cover according to claim 18, which further comprises a third polymer layer being a radially innermost layer relative to the longitudinal axis of the press cover, said second polymer layer being disposed between said third polymer layer and said first polymer layer in radial direction, and said third polymer layer including a prepolymer being a reaction product of:
naphthalene 1,5-diisocyanate as an isocyanate and polytetramethylene ether glycol as a polyol, or
phenylene 1,4-diisocyanate, diphenylmethane 4,4′-diisocyanate, toluene 2,4-diisocyanate or 3,3′-dimethyl-4,4′-biphenylene diisocyanate as an isocyanate and a polyol or polytetramethylene ether glycol.

20. A press cover, comprising:
a single polymer layer, said single polymer layer containing or being formed of a polyurethane, said polyurethane being formed of a prepolymer and a crosslinker; and
said prepolymer being a reaction product of naphthalene 1,5-diisocyanate or phenylene 1,4-diisocyanate as an isocyanate and at least one polyol selected from a polycarbonate polyol, a polytetramethylene ether glycol, polyether polycarbonate polyol or mixtures of a polycarbonate polyol, a polytetramethylene ether glycol and a polyether polycarbonate polyol.

21. A press cover, comprising:
at least one first and one second polymer layer each including or being formed of a polyurethane, said polyurethane being formed of a prepolymer and a crosslinker;
said prepolymer of said first polymer layer being a reaction product of phenylene 1,4-diisocyanate, naphthalene 1,5-diisocyanate, diphenylmethane 4,4′-diisocyanate, toluene 2,4-diisocyanate or 3,3′-dimethyl-4,4′-biphenylene diisocyanate as isocyanate, and at least one polyol selected from a polycarbonate polyol, a polyether polycarbonate polyol or mixtures of a polycarbonate polyol and a polyether polycarbonate polyol; and
said prepolymer of said second polymer layer being a reaction product of naphthalene 1,5-diisocyanate as an isocyanate and polytetramethylene ether glycol as a polyol.

22. The press cover according to claim 21, wherein said first polymer layer is a radially outermost polymer layer relative to a longitudinal axis of the press cover.

23. The press cover according to claim 22, which further comprises a third polymer layer being a radially innermost layer relative to the longitudinal axis of the press cover, said second polymer layer being disposed between said third polymer layer and said first polymer layer in radial direction, and said third polymer layer including a prepolymer being a reaction product of naphthalene 1,5-diisocyanate as an isocyanate and polytetramethylene ether glycol as a polyol.

24. The press cover according to claim 21, wherein said crosslinker includes:
butane-1,4-diol, hydroquinone 1,4-bis(2-hydroxyethyl) ether, 4,4′-methylenebis(3-chloro-2,6-diethylaniline), an aliphatic or aromatic amine, an aliphatic or aromatic diamine, an alkanolamine, ethylenediamine, 2,2,4-trimethylhexane-1,6-diamine, 2,4,4-trimethyl-hexane-1,6-diamine, hexamethylenediamine, diethyltoluenediamine, 4,4′-diaminodicyclohexylmethane, dimethylthiotoluenediamine, monoethanolamine as components or mixtures of said components.

25. The press cover according to claim 19, wherein said crosslinker of said radially outermost polymer layer includes butane-1,4-diol or at least one amine, said crosslinker of said radially innermost polymer layer includes at least one amine, and said respective amines are an aromatic or aliphatic amine, an aromatic or aliphatic diamine or an alkanolamine.

26. The press cover according to claim 23, wherein said crosslinker of said radially outermost polymer layer includes butane-1,4-diol or at least one amine, said crosslinker of said radially innermost polymer layer includes at least one amine, and said respective amines are an aromatic or aliphatic amine, an aromatic or aliphatic diamine or an alkanolamine.

27. The press cover according to claim 25, wherein said crosslinker includes a component selected from at least one polyol or bifunctional polyol having a molecular weight of between 1000 and 4000 g/mol.

28. The press cover according to claim 27, wherein said molecular weight of said component is between 1200 to 3500 g/mol.

29. The press cover according to claim 27, wherein said component is polyester polyol or polycaprolactone polyol; polyether polyols or polytetramethylene ether glycol, polypropylene glycol, polyethylene glycol, polyhexamethylene ether glycol, polycarbonate polyol, polyether carbonate polyol, polybutadiene polyol, perfluoropolyether polyol, silicone polyol or mixtures of said polyols.

30. The press cover according to claim 26, wherein said crosslinker includes a component selected from at least one polyol or bifunctional polyol having a molecular weight of between 1000 and 4000 g/mol.

31. The press cover according to claim 30, wherein said molecular weight of said component is between 1200 to 3500 g/mol.

32. The press cover according to claim 30, wherein said component is polyester polyol or polycaprolactone polyol; polyether polyols or polytetramethylene ether glycol, polypropylene glycol, polyethylene glycol, polyhexamethylene ether glycol, polycarbonate polyol, polyether carbonate polyol, polybutadiene polyol, perfluoropolyether polyol, silicone polyol or mixtures of said polyols.

33. The press cover according to claim 16, wherein said NDI-based prepolymer for production of said at least one polymer layer has an NCO content of 4% to 20% by weight.

34. The press cover according to claim 33, wherein said NCO content is 5% to 14% by weight.

35. The press cover according to claim 21, wherein said NDI-based prepolymer for production of said at least one polymer layer has an NCO content of 4% to 20% by weight.

36. The press cover according to claim 35, wherein said NCO content is 5% to 14% by weight.

37. The press cover according to claim 16, wherein a ratio of an amount of isocyanate actually used in said prepolymer to a calculated stoichiometric amount of isocyanate is between 0.8 and 1.2 for production of said at least one polymer layer.

38. The press cover according to claim 21, wherein a ratio of an amount of isocyanate actually used in said prepolymer to a calculated stoichiometric amount of isocyanate is between 0.8 and 1.2 for production of said at least one polymer layer.

39. The press cover according to claim 19, wherein at least one of a modulus of elasticity or a hardness of said first polymer layer is greater than a corresponding modulus of elasticity or hardness of at least one of said second or third polymer layer.

40. The press cover according to claim 23, wherein at least one of a modulus of elasticity or a hardness of said first polymer layer is greater than a corresponding modulus of elasticity or hardness of at least one of said second or third polymer layer.

41. A press or shoe press for the treatment of a fibrous material web, a paper web, a cardboard web, a tissue web or a pulp web, the press or shoe press comprising a press cover according to claim 16.

42. A press or shoe press for the treatment of a fibrous material web, a paper web, a cardboard web, a tissue web or a pulp web, the press or shoe press comprising a press cover according to claim 20.

43. A press or shoe press for the treatment of a fibrous material web, a paper web, a cardboard web, a tissue web or a pulp web, the press or shoe press comprising a press cover according to claim 21.
